(19) United States
(12) Patent Application Publication
(10) Pub. No.: US 2026/0357887 A1
(43) Pub. Date: Nov. 12, 2026

(54) HAND-OPERATED ACTUATOR AND METHOD FOR CONTROLLING A HAND-OPERATED ACTUATOR

(71) Applicant: Dr. Ing. h.c. F. Porsche Aktiengesellschaft, Stuttgart (DE)

(72) Inventors: Julian Stocks, Stuttgart (DE); Andreas Reichert, Leonberg (DE); Simon Lipphardt, Holzgerlingen (DE); Manuel Kühner, Petersberg (Marbach) (DE)

(73) Assignee: Dr. Ing. h.c. F. Porsche Aktiengesellschaft, Stuttgart (DE)

(21) Appl. No.: 19/673,251

(22) Filed: May 11, 2026

(30) Foreign Application Priority Data
May 12, 2025 (DE) 102025118167.5

(51) Int. Cl. F16H 59/02; B60K 20/04

(52) U.S. Cl. CPC F16H 59/0204; B60K 20/04

(57) ABSTRACT

A hand-operated actuator for the emulated actuation of a transmission of a motor vehicle. The actuator has an actuator housing and an actuating lever. The actuating lever is arranged in the actuator housing so as to be pivotably mounted along at least one actuation path. At least one controllable first actuator is provided, which exerts a force effect on the actuating lever, in order to influence the resistance forces acting on the actuating lever during actuation of the actuating lever, in order to influence the actuation haptics of the actuating lever. At least one controllable second actuator is provided, which exerts a force effect on the actuating lever, in order to influence the resistance forces acting on the actuating lever during actuation of the actuating lever, in order to influence the actuation haptics of the actuating lever. The second actuator is of a different type than the first actuator.

### CROSS-REFERENCE TO RELATED APPLICATION

This application claims priority to German Patent Application No. 10 2025 118 167.5, filed May 12, 2025, the content of such application being incorporated by reference herein in its entirety.

### FIELD OF THE INVENTION

The invention relates to a hand-operated actuator and to a method for controlling a hand-operated actuator, in particular of a motor vehicle.

### SUMMARY OF THE INVENTION

Motor vehicles of the prior art often comprise, for example, a shift lever for shifting a manual transmission or a selector lever for operating an automatic transmission. The shift lever is mechanically coupled to the manual transmission in order to shift the gears of the manual transmission. Such a motor vehicle also comprises a clutch in the drivetrain and a clutch pedal for actuating the clutch. By comparison, a motor vehicle according to the prior art having an automatic transmission comprises no clutch to be actuated by the driver and accordingly also no clutch pedal. The selector lever is mechanically coupled to the automatic transmission.

Such shift levers and such selector levers are typically increasingly being omitted in modern motor vehicles and replaced by actuation buttons, which reduces costs and allows automated electronically controlled actuation of the automatic transmission. However, fully automatic control of motor vehicles is not desired by every driver, because this makes individual intervention by the driver more difficult or prevents it, although this is still preferred by some drivers.

Accordingly, there is a desire for remanualization of motor vehicles in order to be able to manually perform certain functionalities again, such as manual actuation of the automatic transmission as a manual transmission and/or sequential shifting of the automatic transmission, wherein the motor vehicle may also comprise only one electric motor as a drive motor, wherein shifting of the manual transmission or of an automatic transmission is simulated.

For this purpose, however, it is necessary for a hand-operated actuator to be provided and usable, which is equipped with an actuating lever, by means of which, in a first mode, the respective manual actuation of a manually shiftable transmission and/or, in a second mode, sequential shifting of an automatic transmission can be carried out in a simulated manner, such that the hand-operated actuator is suitable both for shifting an automatic transmission and for shifting an automatic transmission in the manner of a manual transmission or can emulate the same. The driver is therefore intended to have the option of whether to drive the vehicle and, in doing so, to shift the existing transmission or, in the case of an electric vehicle, an existing electric motor as if a manual transmission or an automatic transmission were provided. An electronically controllable clutch pedal may also be provided in this case in order to emulate clutch actuation in the case of an emulated manual transmission.

However, it is also desirable for the hand-operated actuator to be suitably controllable in order to provide the operator or the driver of the motor vehicle with a realistic experience of shifting a manual transmission or an automatic transmission. This also includes that the actuating lever is controllably displaceable such that, in the event of an attempt by the driver of the motor vehicle to actuate the actuating lever by application of force at high vehicle speed and a shifting attempt into an inappropriate gear position, the driver experiences blocking of the actuating lever under load and, upon a reduction of the vehicle speed or the engine speed, experiences releasing of the actuation under load. Thus, the driver cannot engage the actuating lever into the inappropriate gear position even under application of a very high actuating force, because this actuation is blocked under load. If the vehicle speed and/or the engine speed decreases and the gear to be engaged thereby becomes permissible, then, if force application continues to be present, the actuating lever may be engaged into the now permissible gear position, and releasing under load takes place.

Described herein is a hand-operated actuator which is equipped with an actuating lever and which is actuatable realistically for generating a realistic shifting experience. Also described is an improved method for controlling a hand-operated actuator which allows a realistic shifting experience.

An exemplary embodiment of the invention relates to a hand-operated actuator, in particular for the emulated actuation of a transmission, in particular of a motor vehicle, having an actuator housing and having an actuating lever, wherein the actuating lever is arranged in the actuator housing so as to be pivotably mounted along at least one actuation path, wherein at least one controllable first actuator is provided, which exerts a force on the actuating lever in order to influence the resistance forces acting on the actuating lever during actuation of the actuating lever, in order to influence the actuation haptics of the actuating lever, wherein at least one controllable second actuator is provided, which exerts a force on the actuating lever in order to influence the resistance forces acting on the actuating lever during actuation of the actuating lever, in order to influence the actuation haptics of the actuating lever, wherein the second actuator is of a different type than the first actuator. In this context, the at least one first actuator serves for the customary shaping of the resistance forces in order to configure the actuation of the actuating lever for the driver to be typical of a shift lever of a motor vehicle having a manually shiftable transmission, and the at least one second actuator serves for blocking under load and releasing under load when higher forces act on the actuating lever, which, however, are not intended to result in the actuating lever being shiftable into a gear position that is not permissible depending on the situation. The different actuators thereby have the capability to apply different magnitudes of force in order to fulfill their respective functions.

It is particularly advantageous if the at least one first actuator is a magnetorheological actuator, wherein at least one magnetic coil or an electromagnet is provided in order to generate a magnetic field which acts on the magnetorheological actuator, and/or if the at least one first actuator is an electric motor actuator. This provides a rapidly controllable actuator, which is provided for shaping a force effect on the actuating lever, in order to influence the resistance forces acting on the actuating lever during actuation of the actuating lever, in order to influence the actuation haptics of the actuating lever.

It is advantageous if the at least one second actuator is a pressure-medium-actuatable actuator. This provides a rapidly controllable actuator that is also capable of transmitting very high forces, for shaping a force effect on the actuating lever, in order to be able to controllably achieve blocking under load and releasing under load. Pressure-medium-actuatable actuators are highly suitable here because they can also transmit very high forces, which results in them also being able to block a high actuating force applied by the driver, should this be necessary.

It is particularly advantageous if the at least one second actuator comprises a solenoid actuator. The solenoid may be a solenoid which is couplable to the actuating lever. The coupling may take place, in particular, mechanically.

Alternatively, it is particularly advantageous if the at least one second actuator comprises a magnetic coil. It is possible here for the actuator, by means of the magnetic coil in the activated state of the magnetic coil, to exert a magnetic force on the actuating lever. An activated state of the magnetic coil may occur, for example, by applying a voltage. Accordingly, the magnetic coil is energized in the activated state.

It is particularly advantageous if the pressure-medium-actuatable actuator comprises a first piston-cylinder unit, which exerts a first force on the actuating lever, and comprises a second piston-cylinder unit, which exerts a second force on the actuating lever, wherein the second force counteracts the first force. In this way, the high forces can be applied in both directions in which the piston-cylinder units act with respect to the actuation direction of the actuating lever. It is also advantageous if the actuating lever comprises a first lever element, at which the displaceable piston of the first piston-cylinder unit engages, and the actuating lever comprises a second lever element, at which the displaceable piston of the second piston-cylinder unit engages. Thus, high forces can also be transmitted to the actuating lever in order to block or release it. In this context, the first lever element and the second lever element form a rocker, wherein the pistons of the piston-cylinder units thereby engage on opposite sides of the rocker in order to release the actuation of the actuating lever under load or to block it under load. The second actuator, as a pressure-medium-actuatable actuator, forms a rocker in order to release or block the controlled actuation of the actuating lever under load.

It is also advantageous if the first piston-cylinder unit is fluidically connected to the second piston-cylinder unit by means of a fluid connection line, wherein a controllable valve and/or a pressure medium reservoir and/or a pressure medium compensation reservoir is arranged in the fluid connection line. Thus, very effective and rapid control of the two piston-cylinder units can be carried out in order to block an actuation of the actuating lever in one or in the other actuation direction or in both actuation directions.

An exemplary embodiment of the invention relates to a method for controlling a hand-operated actuator, in particular for the emulated actuation of a transmission, in particular of a motor vehicle, having an actuator housing and having an actuating lever, wherein the actuating lever is arranged in the actuator housing so as to be pivotably mounted along at least one actuation path, wherein at least one controllable first actuator is provided, which exerts a force effect on the actuating lever in order to influence the resistance forces acting on the actuating lever upon actuation of the actuating lever, in order to influence the actuation haptics of the actuating lever, wherein at least one controllable second actuator is provided, which exerts a force on the actuating lever in order to influence the resistance forces acting on the actuating lever upon actuation of the actuating lever, in order to influence the actuation haptics of the actuating lever, wherein the second actuator is of a different type than the first actuator. Actuators can thus be used which are adapted to their intended use, which makes the configuration effective and cost-effective and allows the driver to generate realistic actuation haptics.

It is also expedient if the at least one second actuator is a pressure-medium-actuatable actuator, which comprises a first piston-cylinder unit, which exerts a first force on the actuating lever, and comprises a second piston-cylinder unit, which exerts a second force on the actuating lever, wherein the second force counteracts the first force, wherein the actuating lever comprises a first lever element, at which the displaceable piston of the first piston-cylinder unit engages, and the actuating lever comprises a second lever element, at which the displaceable piston of the second piston-cylinder unit engages, wherein the control of the second actuator is carried out such that the actuating lever is selectively blockable or releasable in its displaceability, such that an actuation of the actuating lever by the driver is blockable or releasable under load. This makes it possible to generate realistic actuation haptics for the driver.

It is also advantageous if the action of the displaceable piston of the first piston-cylinder unit and the action of the displaceable piston of the second piston-cylinder unit on the actuating lever is controllable by means of a controllable valve. The controllable valve permits control of the flow through the fluid connection line between the piston-cylinder units, which causes the control of the forces on the actuating lever.

It is also expedient if the controllable valve is arranged in the fluid connection line between the first piston-cylinder unit and the second piston-cylinder unit and is controllable such that it blocks a fluid flow between the first piston-cylinder unit and the second piston-cylinder unit or permits a fluid flow from the first piston-cylinder unit to the second piston-cylinder unit or permits a fluid flow from the second piston-cylinder unit to the first piston-cylinder unit. This achieves the control of the forces acting on the actuating lever.

### BRIEF DESCRIPTION OF THE DRAWINGS

In the following, the invention is explained in detail on the basis of exemplary embodiments with reference to the drawings. In the drawings it shows:

FIG. 1 a schematic representation of an exemplary embodiment of a hand-operated actuator having an actuating lever of a motor vehicle for explaining the invention,

FIG. 2 a schematic representation of a further exemplary embodiment of a hand-operated actuator having an actuating lever for explaining the invention,

FIG. 3 a schematic representation of a further exemplary embodiment of a hand-operated actuator having an actuating lever for explaining the invention, and

FIG. 4 a schematic representation of a detail of the exemplary embodiment of a hand-operated actuator having an actuating lever according to FIG. 3.

### DETAILED DESCRIPTION OF THE INVENTION

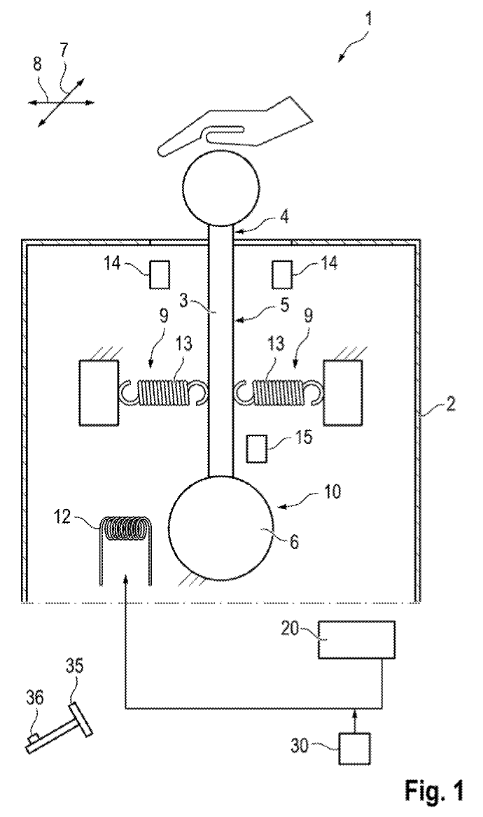

FIG. 1 shows, in a schematic representation, an exemplary embodiment of a hand-operated actuator 1 of a motor vehicle. The hand-operated actuator 1 serves to emulate shifting of a transmission, wherein no mechanical connection is provided between the actuating lever 3 and a transmission or an electric motor, such that shifting of a manual transmission or of an automatic transmission can be performed or emulated in a vehicle having an automatic transmission or electric motor. For this purpose, an electronically controlled clutch pedal 35 may also be provided, which would have to be actuated when shifting the manual transmission.

The hand-operated actuator 1 comprises an actuator housing 2 and an actuating lever 3, which is arranged in the actuator housing 2 so as to be displaceably mounted.

The actuating lever 3 typically comprises a first lever arm region 4 and a second lever arm region 5. The actuating lever 3 is arranged in the actuator housing 2 so as to be pivotably mounted by means of a bearing 6 such that the first lever arm region 4 projects outward from the actuator housing 2, typically upward, and the second lever arm region 5 projects into the actuator housing 2.

Upon a displacement of the actuating lever 3, the actuating lever 3 can be displaced in the actuator housing 2 laterally according to a second actuation direction 7 as well as transversely according to a first actuation direction 8.

According to the shown exemplary embodiment of the hand-operated actuator 1 in FIG. 1, at least one first spring arrangement 9 is provided or a plurality of spring arrangements 9 are provided, which interacts or interact with the actuating lever 3. In this context, the respective spring arrangement 9 is, for example, articulated both on the actuator housing 2 and on the actuating lever 3 in order to transmit a force to the actuating lever 3 in a tensile direction and/or in a compressive direction, such that a first stable rest position is provided in the rest position or central position. As a result, the actuating lever 3 is arranged so as to be mounted by means of the at least one spring arrangement 9 with respect to a first stable rest position.

The tensile direction, for example, is a direction in which the respective spring arrangement 9 exerts a tensile force on the actuating lever 3, and the compressive direction is a direction in which the spring arrangement 9 exerts a compressive force on the actuating lever 3. In the case of two opposing spring arrangements 9, as shown in FIG. 1, the tensile and compressive directions of the respective spring arrangement 9 are reversed.

According to the shown embodiment variant, the spring arrangement 9 comprises at least one spring element 13, which is articulated both on the actuating lever 3 and on the actuator housing 2, such that the actuating lever 3 is arranged so as to be displaceable against a restoring force of the spring element 13, in particular, the spring arrangement 9 comprises at least two spring elements 13, which are articulated both on the actuating lever 3 and on the actuator housing 2, such that the actuating lever 3 is arranged so as to be displaceable against a restoring force of at least one spring element 13.

Furthermore, at least one controllable first actuator 10 is arranged, which acts on the actuating lever 3. Preferably, a plurality of such first actuators 10 is provided.

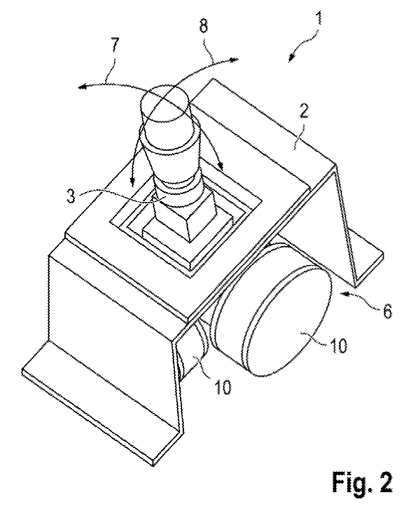

FIG. 2 shows an exemplary embodiment in which two such first actuators 10 are apparent. Each of the two actuators 10 acts in one of the two actuation directions 8, 7 of the actuating lever 3.

The actuating lever 3 may be displaceable in the actuator housing 2 in at least one shift gate or in a plurality of shift gates in the first transverse actuation direction 8 and may be arranged so as to be displaceably mounted transversely to the shift gate or to the shift gates in the second lateral actuation direction 7. Preferably, at least one stable rest position is positioned in a first shift gate.

According to the shown exemplary embodiment, the actuating lever 3 is arranged in a bearing 6 so as to be pivotably mounted about at least one axis, and the at least one first actuator 10 forms the bearing 6 or is a part of the bearing 6.

In a preferred exemplary embodiment, the at least one first actuator 10 is a magnetorheological actuator 10 or comprises such a magnetorheological actuator 10. According to the shown exemplary embodiment, the first actuator 10 comprises at least one magnetic coil 12 or an electromagnet. In this way, the at least one magnetorheological actuator 10 is switched or controlled.

Alternatively, the at least one first actuator 10 may also be, for example, an electric motor actuator 10.

The actuating lever 3 is arranged in the actuator housing 2 so as to be pivotably mounted along at least one actuation path, wherein the respective actuation path provides end stops 14 at its ends, against which the actuating lever 3 can come to rest when it is pivoted to such an extent. However, the spring elements 13 and also the at least one first actuator 10 counteract the displacement of the actuating lever 3 toward the end stops 14.

Accordingly, the at least one controllable first actuator 10 is provided, which exerts a force on the actuating lever 3 in order to influence the resistance forces acting on the actuating lever 3 during actuation of the actuating lever 3, in order to influence the actuation haptics of the actuating lever 3.

The at least one first actuator 10 is, for example, as a magnetorheological actuator 10, a first actuator 10 which brakes or blocks the actuation of the actuating lever 3, wherein the magnitude of the acting force can be controlled. A magnetorheological actuator 10 is therefore suitable for influencing the actuation haptics of the actuating lever 3.

In the shown exemplary embodiment, the actuating lever 3 is arranged so as to be mounted monostably by means of at least one spring arrangement 9 having spring elements 13 with respect to, for example, a rest position. The actuating lever 3 may also be arranged so as to be multistable.

Furthermore, at least one sensor 15 is provided, by means of which the position of the actuating lever 3 is monitored. The actuating force acting on the actuating lever 3 and/or the acceleration of the actuating lever 3 may also be monitored by means of the sensor 15. This indicates how the driver moves the actuating lever 3, with which force and/or with which speed.

Furthermore, a current control circuit 20 is provided for supplying the at least one first actuator 10 and/or the at least one magnetic coil 12 or the at least one electromagnet.

A sensor 36 may also be provided in order to monitor whether the clutch pedal 35 is actuated, which the control unit 30 may take into account when controlling the first actuators 10.

The hand-operated actuator 1 according to aspects of the invention is configured with an actuating lever 3, wherein the actuating lever 3 is displaceably mounted in the actuator housing 2 along at least one actuation path or preferably along two actuation paths. In this context, the actuation paths are provided along the two actuation directions 7, 8.

At least one first controllable actuator 10 is provided or two or more first actuators 10 are provided, as described above. The respective controllable first actuator 10 is provided to exert a force effect on the actuating lever 3, in order to influence the resistance forces acting on the actuating lever 3 during actuation of the actuating lever 3, in order to influence the actuation haptics of the actuating lever 3.

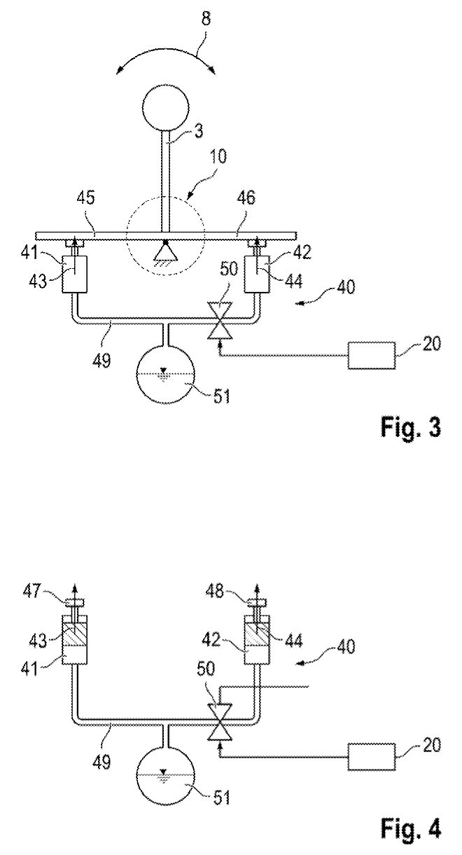

Furthermore, at least one controllable second actuator 40 is provided, as shown in FIG. 3 and in FIG. 4.

The second actuator 40 is provided to exert a force effect on the actuating lever 3, in order to influence the resistance forces acting on the actuating lever 3 during actuation of the actuating lever 3, in order to influence the actuation haptics of the actuating lever 3, wherein the second actuator 40 is of a different type than the first actuator 10. The second actuator 40 is capable of rapidly generating significantly higher forces and transmitting them to the actuating lever 3 in order to block the actuation of the actuating lever 3 under load or to release it under load.

From FIGS. 3 and 4, it can be seen that the at least one second actuator 40 is a pressure-medium-actuatable actuator 40. The pressure-medium-actuatable actuator 40 comprises a first piston-cylinder unit 41, which exerts a first force 43 on the actuating lever 3, and the pressure-medium-actuatable actuator 40 comprises a second piston-cylinder unit 42, which exerts a second force 44 on the actuating lever 3, wherein the second force 44 counteracts the first force 43.

In this context, the actuating lever 3 may comprise a first lever element 45, at which the displaceable piston 47 of the first piston-cylinder unit 41 engages. The actuating lever 3 may also comprise a second lever element 46, at which the displaceable piston 48 of the second piston-cylinder unit 42 engages. In this way, a greater force can also be transmitted to the actuating lever 3 via the pressure-medium-actuatable actuator 40 in order to block, for example, an actuation of the actuating lever 3 by the driver in specific operating situations also under load or also to release it under load.

In this exemplary embodiment, the first lever element 45 and the second lever element 46 form a rocker, wherein the pistons of the piston-cylinder units 41, 42 thereby engage on opposite sides of the rocker in order to release the actuation of the actuating lever 3 under load or to block it under load. The second actuator 40, as a pressure-medium-actuatable actuator, forms a rocker in order to release or block the controlled actuation of the actuating lever 3 under load.

It can further be seen in FIGS. 3 and 4 that the first piston-cylinder unit 41 is fluidically connected to the second piston-cylinder unit 42 by means of a fluid connection line 49. A fluid exchange from the first piston-cylinder unit 41 to the second piston-cylinder unit 42 can thus occur.

It can also be seen that a controllable valve 50 is arranged in the fluid connection line 49. The controllable valve 50 serves to control the fluid flow in the fluid connection line 49. In this way, the control of the second actuator 40 can be carried out such that the actuating lever 3 is selectively blockable or releasable in its displaceability, such that an actuation of the actuating lever 3 by the driver is blockable or releasable under load.

It can also be seen that a pressure medium reservoir 51 and/or a pressure medium compensation reservoir is arranged. This serves to maintain the pressure in the fluid connection line 49 and to keep it at a predefined value.

The control of the second actuator 40 takes place such that the action of the displaceable piston 47 of the first piston-cylinder unit 41 and the action of the displaceable piston 48 of the second piston-cylinder unit 42 on the actuating lever 3 is controllable by means of a controllable valve 50.

In this context, the controllable valve 50 is arranged in the fluid connection line 49 between the first piston-cylinder unit 41 and the second piston-cylinder unit 42, and is controllable such that it blocks a fluid flow between the first piston-cylinder unit 41 and the second piston-cylinder unit 42, or permits a fluid flow from the first piston-cylinder unit 41 to the second piston-cylinder unit 42 while blocking a fluid flow from the second piston-cylinder unit 42 to the first piston-cylinder unit 41, or permits a fluid flow from the second piston-cylinder unit 42 to the first piston-cylinder unit 41 while blocking a fluid flow from the first piston-cylinder unit 41 to the second piston-cylinder unit 42. This makes it possible for the actuating lever 3 to be completely blocked or to be controlled so as to be movable only in one actuation direction 8 or in an opposite actuation direction 8.

In this context, the second actuator 40 is preferably configured such that it influences the actuation of the actuating lever 3 in the transverse first actuation direction 8.

The second actuator 40 is, by way of example, a hydraulic actuator, which comprises two hydraulic cylinder/piston units 41, 42, which permanently bear against the rotationally movable base of the actuating lever 3 with a certain contact pressure. The permanent slight contact pressure is achieved in that the fluid pressure system, for example, the hydraulic system, comprises a pressure medium reservoir 51 and/or a pressure medium compensation reservoir, for example, a gas-pressure compensation reservoir that is under positive pressure.

The piston-cylinder units 41, 42, such as the hydraulic cylinders, are arranged such that one piston 47, 48 of one piston-cylinder unit 41, 42 extends or becomes longer, while the other piston 48, 47 of the other piston-cylinder unit 42, 41 retracts or becomes shorter.

In this context, the shown fluid pressure system of the second actuator 40 can also manage without a pump, in which case it would be passive. Alternatively, however, a pump may also be provided.

Instead of using a valve 50 having three positions, other variants are also conceivable. Thus, for example, a plurality of parallel hydraulic fluid connection lines 49 may also be provided between the cylinders of the piston-cylinder units 41, 42, each having a simpler valve 50 for each fluid connection line 49.

In the shown exemplary embodiment, the valve 50 has at least three positions.

The first position is a completely open position of the valve 50. In this position, the fluid connection line 49 is not influenced. In this position, fluid can flow both from the first piston-cylinder unit 41 to the second piston-cylinder unit 42 and fluid can also flow from the second piston-cylinder unit 42 to the first piston-cylinder unit 41.

Additionally or alternatively, complete blocking of the valve 50 may optionally also take place in an additional fourth position. Then the fluid connection line 49 would be completely blocked.

In a second position of the valve 50, the valve 50 is blocked in the flow direction from the first piston-cylinder unit 41 to the second piston-cylinder unit 42, wherein the opposite flow direction of the valve 50 from the second piston-cylinder unit 42 to the first piston-cylinder unit 41 is open. Fluid can therefore flow only from the second piston-cylinder unit 42 to the first piston-cylinder unit 41, but not back.

In a third position of the valve 50, the valve 50 is blocked in the flow direction from the second piston-cylinder unit 42 to the first piston-cylinder unit 41, wherein the opposite flow direction of the valve 50 from the first piston-cylinder unit 41 to the second piston-cylinder unit 42 is open. Fluid can therefore flow only from the first piston-cylinder unit 41 to the second piston-cylinder unit 42, but not back.

### LIST OF REFERENCE SIGNS

1 hand-operated actuator
2 actuator housing
3 actuating lever
4 first lever arm region
5 second lever arm region
6 bearing
7 second actuation direction
8 first actuation direction
9 spring arrangement
10 first actuator
12 magnetic coil
13 spring element
14 end stops
15 sensor
20 current control circuit
30 control unit
35 clutch pedal
36 sensor
40 second actuator
41 first piston-cylinder unit
42 second piston-cylinder unit
43 first force
44 second force
45 first lever element
46 second lever element
47 piston
48 piston
49 fluid connection line
50 valve
51 pressure medium reservoir

What is claimed is:

1. A hand-operated actuator for emulated actuation of a transmission of a motor vehicle, said hand-operated actuator comprising:
an actuator housing;
an actuating lever arranged in the actuator housing so as to be pivotably mounted along at least one actuation path;
at least one controllable first actuator that exerts a force on the actuating lever in order to influence resistance forces acting on the actuating lever during actuation of the actuating lever thereby influencing actuation haptics of the actuating lever; and
at least one controllable second actuator that exerts a force on the actuating lever in order to influence the resistance forces acting on the actuating lever during actuation of the actuating lever thereby influencing the actuation haptics of the actuating lever,
wherein the second actuator is of a different type than the first actuator.

2. The hand-operated actuator according to claim 1,
wherein the at least one first actuator is a magnetorheological actuator, wherein at least one magnetic coil or an electromagnet generates a magnetic field which acts on the magnetorheological actuator, and/or
wherein the at least one first actuator is an electric motor actuator.

3. The hand-operated actuator according to claim 1,
wherein the at least one second actuator is a pressure-medium-actuatable actuator, and/or
the second actuator comprises a solenoid actuator which is couplable to the actuating lever, and/or
the second actuator comprises a magnetic coil by way of which the at least one second actuator can exert a magnetic force on the actuating lever in an activated state.

4. The hand-operated actuator according to claim 1, wherein the at least one second actuator is a pressure-medium-actuatable actuator, and wherein the pressure-medium-actuatable actuator comprises a first piston-cylinder unit that exerts a first force on the actuating lever and comprises a second piston-cylinder unit that exerts a second force on the actuating lever, wherein the second force counteracts the first force.

5. The hand-operated actuator according to claim 4, wherein the actuating lever comprises a first lever element, at which a displaceable piston of the first piston-cylinder unit engages, and the actuating lever comprises a second lever element, at which a displaceable piston of the second piston-cylinder unit engages.

6. The hand-operated actuator according to claim 4, wherein the first piston-cylinder unit is fluidically connected to the second piston-cylinder unit by way of a fluid connection line,
wherein a controllable valve and/or a pressure medium reservoir and/or a pressure medium compensation reservoir is arranged in the fluid connection line.

7. A method for controlling a hand-operated actuator for emulated actuation of a transmission of a motor vehicle, the hand-operated actuator including an actuator housing, an actuating lever arranged in the actuator housing so as to be pivotably mounted along at least one actuation path, at least one controllable first actuator that exerts a force effect on the actuating lever in order to influence resistance forces acting on the actuating lever during actuation of the actuating lever thereby influencing the actuation haptics of the actuating lever, and at least one controllable second actuator that exerts a force effect on the actuating lever in order to influence the resistance forces acting on the actuating lever during actuation of the actuating lever thereby influencing the actuation haptics of the actuating lever, wherein the second actuator is of a different type than the first actuator, said method comprising:
controlling the hand-operated actuator for the emulated actuation of the transmission of the motor vehicle.

8. The method according to claim 7, wherein the at least one second actuator is a pressure-medium-actuatable actuator, which comprises a first piston-cylinder unit that exerts a first force on the actuating lever and comprises a second piston-cylinder unit that exerts a second force on the actuating lever, wherein the second force counteracts the first force, wherein the actuating lever comprises a first lever element at which a displaceable piston of the first piston-cylinder unit engages and the actuating lever comprises a second lever element at which a displaceable piston of the second piston-cylinder unit engages, wherein control of the second actuator is carried out such that displacement of the actuating lever is selectively lockable or releasable and such that actuation of the actuating lever by the driver under load is lockable or releasable.

9. The method according to claim 8, wherein action of the displaceable piston of the first piston-cylinder unit and action of the displaceable piston of the second piston-cylinder unit on the actuating lever is actuatable by way of a controllable valve.

10. The method according to claim 9, wherein the controllable valve is arranged in a fluid connection line disposed between the first piston-cylinder unit and the second piston-cylinder unit, wherein the controllable valve is controllable to (i) block a fluid flow between the first piston-cylinder unit and the second piston-cylinder unit, (ii) permit fluid flow from the first piston-cylinder unit to the second piston-cylinder unit, or (iii) permit fluid flow from the second piston-cylinder unit to the first piston-cylinder unit.
